(19) United States
(12) Patent Application Publication
(10) Pub. No.: US 2024/0203620 A1
(43) Pub. Date: Jun. 20, 2024

(54) Two-layer buckling resistant lead-free water barrier

(71) Applicant: NEXANS, Courbevoie (FR)

(72) Inventors: Audun JOHANSON, OSLO (NO); Simon JORGENSEN, SELLEBAKK (NO); Massimiliano MAURI, BORGENHAUGEN (NO)

(21) Appl. No.: 18/288,865

(22) PCT Filed: Apr. 12, 2022
(86) PCT No.: PCT/EP2022/059780

§ 371 Date: Oct. 30, 2023

(30) Foreign Application Priority Data
Apr. 12, 2021 (EP) 21305481.0

(51) Int. Cl. H01B 9/02; H01B 13/24

(52) U.S. Cl. CPC H01B 9/02; H01B 13/24

(57) ABSTRACT

A water barrier for encapsulating a cable core has an inner layer of lead-free metal foil having an elastic modulus lower than 210 GPa, an intermediate layer of adhesive material, and an outer layer of a polyethylene-based semi-conducting polymer having an elastic modulus higher than 0.5 GPa. A power cable is providing having such a water barrier.

The present invention relates to a lightweight, lead-free and mechanically reinforced water barrier suited for dynamical submarine power cables.

### BACKGROUND

The current carrying parts of power cables may need to be kept dry. Intrusion of humidity or water may cause electrical breakdown of the power cable insulation system. The core section of power cables is therefore usually protected by a water barrier arranged radially around the cable core. Up to date, the dominating material in water barriers for power cables is lead since lead has proven to be a reliable and sturdy sheathing material.

Several solutions for insulation systems providing water barriers to submarine power cables are known, but all have various disadvantages that should be overcome. One drawback is that lead is a high-density materiel adding significant weight to the cable. The heavy weight induces extra costs in the entire value chain from production, under transport, storage, deployment, and when the cable is discarded after reaching its lifetime. Another drawback is that lead has a relatively low fatigue resistance making leaden water barriers less suited for dynamical power cables. Furthermore, lead is a rather poisonous material increasingly meeting environmental regulation restrictions. An environmentally friendly replacement of lead as water barrier in power cables is required.

EP 2 312 591 discloses a submarine power cable comprising an electrical conductor surrounded by an insulation. The insulation is surrounded by a metallic moisture barrier. The cable further comprises a semi-conductive adhesive layer surrounding said metallic moisture barrier, and a semi-conductive polymeric jacket able to be in electrical contact with sea water surrounding said semi-conductive adhesive layer.

WO 2019/223878 discloses a power cable comprising an insulated conductor; a copper water barrier, in form of a tube with a welding line, surrounding each insulated conductor; and a polymeric sheath surrounding each copper water barrier. A ratio between the thickness of the copper water barrier and the thickness of the polymeric sheath is 0.15 or less.

### Objective of the Invention

The main objective of the invention is to provide a lightweight, lead-free and mechanically reinforced water barrier suitable for dynamical submarine power cables.

### SUMMARY OF THE INVENTION

The present invention is defined by the appended claims and in the following.

In a first aspect, the invention relates to a water barrier for surrounding a cable core, wherein the water barrier comprises:
an inner layer of lead-free metal foil having an elastic modulus lower than 210 GPa,
an intermediate layer of adhesive material, typically and preferably based on an organic polymer; and
an outer layer of a polyethylene-based semi-conducting polymer having an elastic modulus higher than 0.5 GPa.

The elastic modulus is measured according to ASTM E111 for metals and to ISO 527-1, -2 for polymers.

The term “layer of metal foil” or “metal foil layer” as used herein, refers to the metal layer acting as the water barrier. The invention is not tied to use of any specific metal/metal alloy or thickness of the metal foil. Any metal/metal alloy at any thickness known to be suited for use in water barriers in power cables by the skilled person may be applied. The metal foil can be welded or otherwise placed so that metal foil forms a waterproof barrier.

In another embodiment, the inner layer of lead-free metal foil has a thickness of t₁, the outer layer of a polyethylene-based semi-conducting polymer has a thickness of t₂, and the ratio t₁:t₂ may be at least 0.15.

In another embodiment, the ratio t₁:t₂ may be at least 0.16, at least 0.17, at least 0.18, at least 0.19, at least 0.20, at least 0.30, at least 0.40, at least 0.50 or at least 1.00. In another embodiment, the ratio t₁:t₂ may be between 0.15 and 10.

This difference in thickness combined with the respective elastic modulus (Youngs modulus) of the different layers will allow to obtain the required mechanical reinforcement to make the water barrier fatigue resistant and tolerate the cable being bended without the metal foil layer becoming buckled.

In another embodiment, the layer of lead-free metal foil has an elastic modulus lower than 200 GPa, lower than 190 GPa, lower than 180 GPa, lower than 170 GPa, lower than 160 GPa, or lower than 150 GPa. In another embodiment, the layer of lead-free metal foil has an elastic modulus between 50 GPa and 200 GPa.

In one example embodiment, the metal foil may be either an Al/Al-alloy such as for example pure Al, an AA1xxx series, an AA5xxx series or an AA6xxx series alloy according to the Aluminium Association Standard, or a Cu/Cu-alloy such as for example pure Cu, a CuNi-alloy or a CuNiSi-alloy, or a Fe/Fe-alloy, such for example pure Fe, stainless alloy SS316 or S32750.

In another embodiment, the metal foil may be is pure copper or a copper alloy. In a preferred embodiment, the metal foil may be pure copper, a CuNi- or a CuNiSi-alloy. The term “pure” is used herein to refer to less than 1 weight-% impurities.

In one embodiment, the metal foil is an alpha Ti based material, a near alpha Ti based material or an alpha-beta Ti based material.

In one embodiment the alpha Ti based material is selected from
a pure Ti material that has a Ti content of at least 98.5% by weight, a Fe content from 0 to 0.5% by weight, O content from 0 to 0.5% by weight and a content of incidental elements and impurities from 0 to 0.5% by weight based on the total weight of the pure Ti material, and wherein the content of Ti, Fe, O and incidental elements and impurities sum up to 100% by weight;
a Ti alloy that has a Ti content from 95% to 98% by weight, a Cu content from 2% to 4% by weight and a content of incidental elements and impurities 0 to 1% by weight based on the total weight of the Ti alloy, and wherein the content of Ti, Cu and incidental elements and impurities sum up to 100% by weight.
a Ti alloy that has a Ti content of from 89% to 94% by weight, a Al content from 4% to 6% by weight, a Sn content from 2% to 4% by weight and a content of incidental elements and impurities from 0 to 1% by weight based on the total weight of the Ti alloy, and wherein the content of Ti, Al, Sn and incidental elements and impurities sum up to 100% by weight.

In one embodiment the near alpha Ti based material is selected from
a Ti alloy that has a Ti content from 87% to 91% by weight, a Al content from 7% to 9% by weight, a Mo content from 0.5% to 2% by weight, a V content from 0.5% to 2% by weight and a content of incidental elements and impurities from 0 to 1% by weight based on the total weight of the Ti alloy, and wherein the content of Ti, Al, Mo, V and incidental elements and impurities sum up to 100% by weight;
a Ti alloy that has a Ti content from 86% to 92.5% by weight, a Al content from 5% to 7% by weight, a Mo content from 0.4% to 2% by weight, a Nb content from 1% to 3% by weight, a Ta content from 0.1% to 2% by weight and a content of incidental elements and impurities from 0 to 1% by weight based on the total weight of the Ti alloy, and wherein the content of Ti, Al, Mo, V and incidental elements and impurities sum up to 100% by weight;
a Ti alloy that has a Ti content from 89% to 91.9% by weight, a Al content from 5% to 7% by weight, a Mo content from 3% to 5% by weight, a Sn content from 1% to 3% by weight, a Si content from 0.1% to 2% by weight and a content of incidental elements and impurities from 0 to 1% by weight based on the total weight of the Ti alloy, and wherein the content of Ti, Al, Mo, Sn, Si and incidental elements and impurities sum up to 100% by weight;
a Ti alloy that has a Ti content from 82% to 89% by weight, a Al content from 5% to 7% by weight, a Mo content from 1% to 3% by weight, a Sn content from 1% to 3% by weight, a Zr content from 3% to 5% by weight and a content of incidental elements and impurities from 0 to 1% by weight based on the total weight of the Ti alloy, and wherein the content of Ti, Al, Mo, Sn, Zr and incidental elements and impurities sum up to 100% by weight; and
a Ti alloy that has a Ti content from 83% to 88.9% by weight, a Al content from 3% to 5% by weight, a Mo content from 3% to 5% by weight, a Zr content from 4% to 6% by weight, a Si content from 0.1% to 1% by weight and a content of incidental elements and impurities from 0 to 1% by weight based on the total weight of the Ti alloy, and wherein the content of Ti, Al, Mo, Zr, Si and incidental elements and impurities sum up to 100% by weight.
a Ti alloy that has a Ti content from 80.5% to 87.5% by weight, a Al content from 5% to 7% by weight, a Mo content from 0.1% to 1% by weight, a Nb content from 0.3% to 1% by weight, a Sn content from 3% to 5% by weight, a Zr content from 3% to 5% by weight, a Si content from 0.1% to 0.5% by weight and a content of incidental elements and impurities from 0 to 1% by weight based on the total weight of the Ti alloy, and wherein the content of Ti, Al, Mo, Nb, Sn, Zr, Si and incidental elements and impurities sum up to 100% by weight.

In one embodiment the alpha-beta Ti based material is selected from a Ti alloy that has a Ti content from 87% to 92% by weight, a Al content from 5% to 7% by weight, a V content from 3% to 5% by weight and a content of incidental elements and impurities from 0 to 1% by weight based on the total weight of the Ti alloy, and wherein the Ti content, Al content, V content and content of incidental elements and impurities sum up to 100% by weight.

In one embodiment, the metal foil is selected from commercially pure Sn, Sn—Cu and Sn—Sb.

In one embodiment, the metal foil is selected from
commercially pure Sn material that has a Sn content of at least 99.5% by weight and a content of incidental elements and impurities from 0 to 0.5% by weight based on the total weight of the pure Sn material, and wherein the content of Sn and incidental elements and impurities sum up to 100% by weight;
a Sn alloy that has a Sn content from 97%-99.5% by weight, a Cu content from 0.5% to 2% by weight and a content of incidental elements and impurities of 0 to 1% by weight based on the total weight of the Sn alloy, and wherein the content of Sn, Cu and incidental elements and impurities sum up to 100% by weight; and
a Sn alloy that has a Sn content from 93%-96% by weight, a Sb content from 4% to 6% by weight and a content of incidental elements and impurities of 0 to 1% by weight based on the total weight of the Sn alloy, and wherein the content of Sn, Cu and incidental elements and impurities sum up to 100% by weight.

In one embodiment, the metal foil (or the metallic tube) may preferably be non-corrugated in order to get a substantially 100% void-free interface between the intermediate layer of adhesive material and said metal foil layer (or said metallic tube).

The thickness, t₁, of the metal foil layer may in an example embodiment be in one of the following ranges from 50 to 1000 μm, preferably from 100 to 700 μm, more preferably from 150 to 500 μm.

The term “layer of adhesive material” or “adhesive layer” as used herein, refers to the intermediate layer acting as an adhesive between the metal foil layer and the outer layer of a semi-conductive polyethylene-based polymer.

In another embodiment, the intermediate layer of adhesive material is a semi-conductive adhesive layer.

In another embodiment, the intermediate layer of adhesive material is a hot melt adhesive layer.

The thickness of the intermediate layer of adhesive material may in an exemplary embodiment be within one of the following ranges; from 100 to 300 μm, preferably from 100 to 250 μm, more preferably from 100 to 200 μm, and most preferably from 100 to 150 μm.

The term “layer of a semi-conductive polyethylene-based polymer” as used herein, refers to the polymer layer laid onto the adhesive layer and metal foil layer and functions as a mechanical reinforcement of the water barrier metal foil layer.

The polyethylene-based polymer may in one example embodiment be made of a low density polyethylene (LDPE), a linear low density polyethylene (LLDPE), a medium density polyethylene (MDPE), or a high density polyethylene (HDPE) constituted of a copolymer of ethylene with one or more polar monomers of acrylic acid, methacrylic acid, glycidyl methacrylate, maleic acid, or maleic anhydride.

Examples of suitable polyethylene-based polymers include, but are not limited to: copolymer of ethylene and ethyl acrylate or similar acrylates; copolymer of ethylene and ethyl acrylic acid, methacrylic acid or similar; copolymer of ethylene and glycidyl methacrylate or similar epoxy-based monomer such as 1,2-epoxy-1-butene or similar; or copolymer of ethylene and maleic-anhydride, or similar.

The outer layer of a polyethylene-based semi-conducting polymer may in one example embodiment have an elastic modulus of at least 0.5 GPa. In another embodiment it may have an elastic modulus of least 0.7 GPa. In another embodiment it may have an elastic modulus of at least 0.8 GPa. In another embodiment it may have an elastic modulus of at least 0.9 GPa. In another embodiment it may have an elastic modulus of at least 1.0 GPa. The outer layer of a polyethylene-based semi-conducting polymer according to the present invention may have an elastic modulus between 0.5 GPa and 20 GPa, between 0.5 GPa and 15 GPa or between 0.5 GPa and 10 GPa.

The polyethylene-based polymer may in one exemplary embodiment be made electrically semi-conducting by addition and homogenisation 4 to 40 weight % particulate carbon, silver or aluminum in the polymer mass to enable carrying away capacitive charges.

Examples of suitable particulate carbon include but are not limited to; comminuted petrol coke, comminuted anthracite, comminuted char coal, carbon black, carbon nanotubes, etc.

In another embodiment, the particulate carbon may be carbon black.

The term “semi-conducting” as used herein, refers to middle level of electric conductivity, i.e. an electric conductivity falling between the electric conductivity of an electric conductor and an electric insulator.

In another embodiment the thickness t₂ of the polyethylene-based semi-conducting polymer layer may be from 1.5 to 5 mm, preferably from 1.5 to 3 mm, and most preferably from 1.5 to 2 mm.

In a second aspect, the invention relates to a power cable comprising the water barrier according to the first aspect of the invention.

In an embodiment of the power cable, the water barrier may be the outermost layer of the cable.

In another embodiment of the power cable, the water barrier may be covered with armouring and/or an outer mantel.

In another aspect, the invention relates to a method of manufacturing a water barrier for surrounding a cable core, the method comprising the steps of:
providing a layer of lead-free metal foil,
welding said layer around the cable core,
depositing onto the outer surface of the metal foil layer by extrusion an layer of adhesive material,
depositing onto the outer surface of the intermediate layer of adhesive material (5) by extrusion a layer of a polyethylene-based polymer having an elastic modulus higher than 0.5 GPa.

In another embodiment, the inner layer of lead-free metal foil has a thickness of t₁, the outer layer of a polyethylene-based semi-conducting polymer has a thickness of t₂, and the ratio t₁:t₂ may be at least 0.15.

In another embodiment, the metal foil layer is thoroughly cleaned from grease and dirt before this process.

### SHORT DESCRIPTION OF THE DRAWINGS

The present invention is described in detail by reference to the following drawings:

FIG. 1 is a cross-sectional view of a schematic illustration of an embodiment of the lead-free buckling resistant water barrier around an insulated electrical conductor.

### DETAILED DESCRIPTION OF THE INVENTION

High-voltage subsea power cables operating with highest continuous voltage (Um) over 72.5 kV are required to be dry, and they are usually sheathed with a lead water-barrier at Um>36 kV as recommended by IEC 60840. Lead sheathing has been under scrutiny because of the negative impact of lead on the environment and will most likely be banned in the future. This means that alternative solutions need to be developed.

The use of a lead-free metal and polyethylene laminate as water barrier has been evaluated as an alternative solution. A challenge associated with water barriers of stiffer materials such as welded copper is reduced buckling resistance under bending.

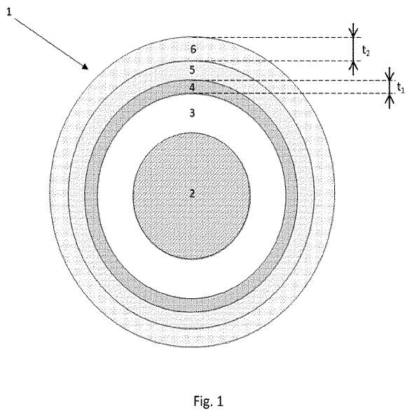

Use of a water barrier according to the present invention in a dry high voltage subsea power cable 1 is illustrated in FIG. 1. An electrical conductor 2 is surrounded by an insulation system 3. Said electrical conductor 2 and insulation system 3 are known in the art. Around this isolated cable conductor 2-3, an inner layer of metal foil 4 having a thickness of t₁ is arranged and welded.

Around the inner layer of metal foil 4, an intermediate layer of adhesive material 5 is arranged to ensure adhesion of an outer layer of a polyethylene-based polymer 6 having a thickness of t₂ to the metal foil layer.

FIG. 1 is a schematic illustration of an embodiment of the lead-free buckling resistant water barrier around an insulated electrical conductor. The thickness of the layers represented therein is not representative.

The assembled inner layer of metal foil 4, intermediate layer of adhesive material 5 and outer layer of a polyethylene-based polymer 6 form the water barrier of the present invention.

### The Metal Foil Layer 4

The metal foil layer 4 according to the present invention can have a thickness needed to meet electrical property requirements and fatigue resistance according to the invention.

The metal foil layer 4 according to the present invention can have an elastic modulus lower than 210 GPa, preferably lower than 150 GPa.

The metal foil layer 4 is formed from a conducting lead-free metal, preferably a copper, steel, titan, tin or aluminum alloy. The lead-free metal is preferably readily weldable. In an exemplary embodiment, the metal foil is an Al/Al-alloy such as for example an AA1xxx series, an AA5xxx series or an AA6xxx series alloy according to the Aluminium Association Standard, or a Cu/Cu-alloy such as for example pure Cu, a CuNi-alloy or a CuNiSi-alloy, or a Fe/Fe-alloy, for example stainless alloy SS316 or S32750.

A preferred metal foil 4 is made of copper, preferably pure Cu or a CuNiSi-alloy.

Titanium is a strong and light metal and is thus particular suitable for use in dynamic power cables.

It is well known that titanium and its alloys have different properties, wherein the alpha based alloys are less affected by heat treatment and microstructural variations followed by a welding operation compared to beta-phase based titanium and titanium alloys.

Thus, the titanium and titanium alloy for use in the metal foil layer 4 can be selected from alpha titanium-based materials, alpha titanium-based alloys, near alpha titanium-based alloys and alpha-beta titanium-based alloys.

The above-mentioned titanium and titanium alloys exhibit negligible corrosion rate in seawater and other natural waters and its corrosion resistance is superior over steel and copper metal/alloys.

Table 1 to 4 below depicts further details and embodiments of the metal foil layer 4 material.

TABLE 1

| Pure titanium | Grades 1 to 4 |
|---|---|
| Ti [wt %] | >=99 |
| *Incidental elements and impurities [wt %] | 0-1 |

wherein the amount of oxygen and iron does not exceed 0.5 [wt %] each.

TABLE 2

| Alpha alloys | Alloy 2 | Alloy 3 |
|---|---|---|
| Ti [wt %] | 95-98 | 89-94 |
| Cu [wt %] | 2-4 | |
| Al [wt %] | | 4-6 |
| Sn [wt %] | | 2-4 |
| *Incidental elements and impurities [wt %] | 0-1 | 0-1 |

wherein the amount of oxygen and iron does not exceed 0.5 [wt %] each.

TABLE 3

| Near alpha alloys | Alloy 1 | Alloy 2 | Alloy 3 | Alloy 4 | Alloy 5 | Alloy 6 |
|---|---|---|---|---|---|---|
| Ti [wt %] | 87-91 | 86-92.5 | 89-91.9 | 82-89 | 83-88.9 | 80.5-87.5 |
| Al [wt %] | 7-9 | 5-7 | 3-5 | 5-7 | 3-5 | 5-7 |
| Mo [wt %] | 0.5-2 | 0.4-2 | 3-5 | 1-3 | 3-5 | 0.1-1 |
| V [wt %] | 0.5-2 | | | | | |
| Nb [wt %] | | 1-3 | | | | 0.3-1 |
| Ta [wt %] | | 0.1-2 | | | | |
| Sn [wt %] | | | 1-3 | 1-3 | | 3-5 |
| Zr [wt %] | | | | 3-5 | 4-6 | 3-5 |
| Si [wt %] | | | 0.1-2 | | 0.1-1 | 0.1-0.5 |
| Cu [wt %] | | | | | 0.4-2 | |
| Incidental | 0-1 | 0-1 | 0-1 | 0-1 | 0-1 | 0-1 |
| elements and | | | | | | |
| impurities [wt %] | | | | | | |

TABLE 4

| Alpha-beta alloy | Alloy 1 |
|---|---|
| Ti [wt %] | 87-92 |
| Al [wt %] | 5-7 |
| V [wt %] | 3-5 |
| Incidental elements and impurities [wt %] | 0-1 |

It is noted that any percentage amount of a metal component in an alloy described herein is provided as a fraction of the weight of the metal per total weight of the alloy as a percentage, or [wt %].

It will be appreciated by a skilled person that, for titanium and titanium alloy as exemplified in table 1 to 4, where a range of a percentage amount of a metal in an alloy is given, the amount of metal in that alloy may vary within that range, provided the total amount of all metals in that alloy adds up to a total of 100 wt %. It will also be appreciated that some metals and alloys may inevitably have very small quantities of impurities within them. These impurities may be present since they are typically either too difficult or costly to remove when the metal or alloy is being produced. These impurities may be present in the range from 0.0001%, 0.001%, 0.005% or 0.01% to 0.1%, 0.5%, 1% (wt) based on the total weight of the alloy and wherein each impurity does not exceed 0.5% by weight based on the total weight of the alloy. It will be appreciated such impurities may be present in the metals and alloys of the present invention without affecting or departing from the scope of the invention and comprises the following substances iron, nitrogen, carbon, oxygen and hydrogen.

Titanium exists in two crystallographic forms. At room temperature, unalloyed commercially pure titanium has a hexagonal close-packed (hcp) crystal structure referred to as alpha (α) phase. When the temperature of pure titanium reaches 885° C. (called the β transus temperature of titanium), the crystal structure changes to a bcc structure known as beta (β) phase. Alloying elements either raise or lower the temperature for the α-to-β transformation, so alloying elements in titanium are classified as either a stabilizers or β stabilizers. For example, vanadium, niobium, chromium, manganese and molybdenum decrease the α-to-β transformation temperature and promote the formation of the β phase, while elements such as oxygen, nitrogen and aluminium are stabilizers of the α-phase.

Pure Ti material grade 1 to 4 is considered an alpha alloy because that alpha-phase is the only phase present. The material has a minimum of 99% (wt) titanium and incidental elements and impurities of Fe, C, N, O and H that are interstitial solutes in the alpha phase, wherein the content of Fe and O may not exceed 0.5% (wt) each.

Common alpha Ti alloys comprise one or more of Cu, Al or Sn which are stabilizers of the alpha phase, cf. table 2.

The near Ti alpha alloys and alpha-beta Ti alloys comprises alloy elements that support both an alpha phase and a beta phase.

A near alpha Ti alloy is an alloy that comprises both alpha and beta phase stabilizer, cf. table 3 above, but wherein the amount of alloy elements that stabilizes the alpha phase is higher compared to the amount of alloy elements that stabilizes the beta phase.

An alpha-beta alloy is an alloy that comprises both alpha and beta phase stabilizer, cf. table 3 above, but wherein the amount of alloy elements that stabilizes the alpha phase is higher compared to the amount of alloy elements that stabilizes the beta phase, but wherein the amount of alloy elements that stabilizes the beta phase is higher compared to the amount of beta phase stabilizing elements of the near alpha alloys, cf. table 4.

Further the metal foil layer 4 may be the ASTM grade 1 Pure Ti material with an alpha phase.

The metal foil layer 4 may be the ASTM grade 2 Pure Ti material with an alpha phase.

The metal foil layer 4 may be the ASTM grade 3 Pure Ti material with an alpha phase.

The metal foil layer 4 may be the ASTM grade 4 Pure Ti material with an alpha phase.

The metal foil layer 4 may be the alpha alloy Ti-2.5Cu.

The metal foil layer 4 may be the alpha alloy Ti-5Al-2.5Sn.

The metal foil layer 4 may be the near-alpha alloy Ti-8Al-1Mo-1V.

The metal foil layer 4 may be the near-alpha alloy Ti-6Al-0.8Mo-2Nb-1Ta.

The metal foil layer 4 may be the near-alpha alloy IMI550 (Ti-4Al-4Mo-2Sn-0.5Si).

The metal foil layer 4 may be the near-alpha alloy Ti-6Al-2Mo-4Zr-2Sn.

The metal foil layer 4 may be the near-alpha alloy IMI700 (Ti-6Al-4Mo-5Zr-1.25Cu-0.25Si). The metal foil layer 4 may be the near-alpha alloy IMI834 (Ti-6Al-4Sn-4Zr-0.7Nb-0.5Mo-0.3Si)

The metal foil layer 4 may be the alpha-beta alloy Ti-6Al-4V.

Similar to lead, tin is a soft, malleable and highly ductile metal with a relatively low melting temperature of around 232ºC.

It is well known that tin and its alloys can have different crystal structures, wherein the alpha-tin crystal structure has a face-centred diamond-cubic structure and beta-tin has a body-centred tetragonal crystal structure. In cold conditions beta-tin can transform spontaneously into alpha-tin, a phenomenon known as “tin pest” or “tin disease”. Commercially pure grades of tin with a tin content of at least 99.5% resists transformation because of the inhibitory effect of small amounts of bismuth, antimony, lead and silver present as incidental elements and impurities. Alloying element such as copper (Cu) and antimony (Sb) also increase the hardness of tin (Sn). Thus, the tin and tin-alloys for use in a metal foil layer 4 are selected from commercially pure tin, a Sn—Cu alloy or a Sn—Sb alloy. Tables 5 and 6 below depicts further details and embodiments of the metal foil layer 4 materials.

TABLE 5

| Commercially pure tin | |
|---|---|
| Sn [wt %] | >=99.5 |
| Incidental elements and impurities [wt %] | 0-0.5 |

TABLE 6

| | Alloy 1 | Alloy 2 |
|---|---|---|
| Sn [wt %] | 97-99.5 | 93-96 |
| Cu [wt %] | 0.5-2 | |
| Sb [wt %] | | 4-6 |
| Incidental elements and impurities [wt %] | 0-1 | 0-1 |

It is noted that any percentage amount of a metal component in an alloy described herein is provided as a fraction of the weight of the metal per total weight of the alloy as a percentage, or [wt %].

It will be appreciated by a skilled person that, for tin and tin alloy as exemplified in table 5 and 6, where a range of a percentage amount of a metal in an alloy is given, the amount of metal in that alloy may vary within that range, provided the total amount of all metals in that alloy adds up to a total of 100 wt %. It will also be appreciated that some metals and alloys may inevitably have very small quantities of impurities within them. These incidental elements and impurities may be present since they are typically either too difficult or costly to remove when the metal or alloy is being produced. These impurities may be present in the range from 0.0001%, 0.001%, 0.005% or 0.01% to 0.1%, 0.5%, 1% (wt) based on the total weight of the alloy and wherein each impurity does not exceed 0.5% by weight based on the total weight of the alloy. It will be appreciated such impurities may be present in the metals and alloys of the present invention without affecting or departing from the scope of the invention and comprises the following substances bismuth, antimony, lead and silver.

The metal foil layer 4 may be commercially pure Sn.

The metal foil layer 4 may be a Sn-0.7Cu alloy.

The metal foil layer 4 may be a Sn-5Sb alloy.

The most preferred design of the metal foil layer 4 is a tube, so that the metal foil layer 4 is preferably a metallic tube.

The metal foil layer 4 may be obtained from a strip of metal, which can be wrapped around the insulation of the electrical conductor. Then the metallic strip may be longitudinally welded to form an exogenous or autogenously welded metallic tube.

The diameter of the welded sheath may thereby be reduced by either drawing or rolling.

The metal foil 4 (or the metallic tube) may preferably be non-corrugated to obtain a substantially 100% void-free interface between the semi-conductive adhesive layer 5 and said metal foil layer 4 (or said metallic tube).

The thickness, t₁, of the metal foil layer 4 may in an exemplary embodiment be in one of the following ranges; from 50 to 1000 μm, preferably from 100 to 700 μm, more preferably from 150 to 500 μm.

### The Semi-Conductive Adhesive Layer 5

In the present application, the generic term “polymer” is intended to encompass both “homopolymer” and “copolymer”.

The semi-conducting adhesive layer 5 provides excellent electrical contact between the metallic moisture barrier and the semi-conductive polymeric jacket. The semi-conducting adhesive layer 5 can be made from a composition comprising:
an organic polymer, being preferably easily extrudable, as similar chemical nature as the polymer material of the semi-conductive polymeric jacket, said organic polymer being modified (e.g. grafted) with a monomer with a reactive carboxyl group, such as acrylic acid or acrylic acid ester, and
a semi-conducting filler in a sufficient loading to render said layer semi-conductive, such as by example a loading from 4 to 30% by weight of the composition.

Said composition can further comprise at least one additive selected among protecting agents against aging phenomena; metal deactivators; adhesion promoters; tackifiers; process aids such as lubricants; coupling agents; and flame-retardant fillers; or one of their mixtures.

Said organic polymer can typically be a thermoplastic or an elastomeric polymer material such as, for example, a polyolefin, and more particularly an ethylene based polymer.

The semi-conductive filler can be silver, aluminium or carbon filler, and more particularly carbon black filler.

The protecting agent (or combination of protecting agents) may include antioxidants well-known in the art. By way of example, one cites sterically hindered phenols, especially sterically hindered phenols acting as metal deactivators like Irganox MD 1024 commercialized by Ciba Specialty Chemicals, phosphonite- or phosphite-based antioxidants like Irgafos 168 commercialized by Ciba Specialty Chemicals and amine-based antioxidants such as polymerized 2,2,4-trimethyl-1,2 dihydroquinoline (TMQ).

The preferred semi-conductive adhesive layer 5 is a semi-conductive hot melt adhesive layer, that can be for example based on maleic anhydride, such as Yparex 9403M, Yparex 0H286 or PRE-ELEC 18500. Well-known semi-conductive hot melt adhesive materials, which can be used in the invention, can be for example the reference N 2910 BG commercialized by Nexans France.

Other hot melt adhesive materials, which are not semi-conductive as such, can be either added to one which is semi-conductive, or mixed as such with semi-conductive filler. Said hot melt adhesive materials which are not semi-conductive can be one of the following brands: Yparex (a maleic anhydride modified polyethylene) commercialized by DSM; Fusabond (an anhydride modified polyethylene) commercialized by Dupont; Orevac (an ethylene vinyl acetate based terpolymer) or Lotader (an ethylene acrylate based terpolymer) commercialized by Arkema.

Furthermore, the semi-conductive adhesive layer can advantageously be not cross-linked.

Testing of the adhesion of the semi-conductive polymeric layer 6 onto the metal foil layer 4 may be conducted according to IEC62067. To be sufficient, the peeling strength shall be more than 0.5 N/mm according to IEC62067.

### The Semi-Conductive Polymeric Jacket 6

The semi-conductive polymeric jacket or layer 6 is typically any polyethylene-based polymer used in electrical insulation applications. The polyethylene-based polymer is preferably easily extrudable. The polyethylene-based polymer has been rendered semi-conductive by incorporation of an electrically semi-conductive filler.

The polyethylene-based polymer may in one example embodiment be either a low density polyethylene (LDPE), a linear low density polyethylene (LLDPE), a medium density polyethylene (MDPE), or a high density polyethylene (HDPE) constituted of a copolymer of ethylene with one or more polar monomers of acrylic acid, methacrylic acid, glycidyl methacrylate, maleic acid, or maleic anhydride or any combination thereof.

Examples of suitable polyethylene-based polymers include, but are not limited to:
copolymer of ethylene and ethyl acrylate or similar acrylates;
copolymer of ethylene and ethyl acrylic acid, methacrylic acid or similar;
copolymer of ethylene and glycidyl methacrylate or similar epoxy-based monomer such as 1,2-epoxy-1-butene or similar; or
copolymer of ethylene and maleic-anhydride, or similar.

The outer layer of a polyethylene-based semi-conducting polymer 6 according to the present invention can have an elastic modulus of at least 0.5 GPa, at least 0.7 GPa, at least 0.8 GPa, at least 0.9 GPa, or at least 1.0 GPa. The outer layer of a polyethylene-based semi-conducting polymer 6 according to the present invention may have an elastic modulus between 0.5 GPa and 20 GPa.

The polyethylene-based polymer may in one example embodiment be made electrically semi-conducting by addition and homogenisation of 4 to 40 weight % particulate carbon, silver or aluminium in the polymer mass to enable carrying away capacitive charges.

Examples of suited particulate carbon includes but is not limited to: comminuted petrol coke, comminuted anthracite, comminuted char coal, carbon black, carbon nanotubes, etc.

The preferred semi-conductive polymer layer 6 has incorporated therein a loading of carbon black from 4 to 30% by weight of the composition.

According to a particular embodiment of the invention, the semi-conductive polymeric layer 6 can be the outermost layer of the cable.

Furthermore, the semi-conductive polymeric layer 6 may be not cross-linked.

### Outer Layer

The submarine power cable comprising the water barrier according to the invention may also comprise an additional outer layer. The outer layer may for example be an armouring layer or an outer mantel.

1. A water barrier for surrounding a cable core, wherein the water barrier
comprises:
an inner layer of lead-free metal foil having an elastic modulus lower than 210 GPa,
an intermediate layer of adhesive material, and
an outer layer of a polyethylene-based semi-conducting polymer having an elastic modulus higher than 0.5 GPa.

2. The water barrier according to claim 1, wherein the inner layer of lead-free metal foil has a thickness of t₁ and the outer layer of a polyethylene-based semi-conducting polymer has a thickness of t₂,
wherein the ratio t₁:t₂ is at least 0.15.

3. The water barrier according to claim 1, wherein the metal foil has an elastic modulus lower than 150 GPa.

4. The water barrier according to claim 1, wherein the metal foil layer is non-corrugated.

5. The water barrier according to claim 1, wherein the thickness t₁ of the metal foil is from 50 to 1000 μm.

6. The water barrier according to claim 1, wherein the metal foil is either:
aluminium,
an aluminium alloy of the AA1xxx series, AA5xxx series or the AA6xxx series according to the Aluminium Association Standard,
copper,
a copper-alloy,
a CuNi-alloy,
a CuNiSi-alloy age hardened to T6,
iron,
a Fe-alloy
stainless steel alloy SS316,
or
stainless steel alloy S32750.

7. The water barrier according to claims, wherein the metal foil is pure copper or a Cu-alloy.

8. The water barrier according to claim 1, wherein the intermediate layer of adhesive material is a hot melt adhesive layer.

9. The water barrier according to claim 1, wherein the intermediate layer of adhesive material has a thickness of from 100 to 300 μm.

10. The water barrier according to claim 1, wherein the polyethylene-based semi-conducting polymer is a polymer selected from: a low density polyethylene (LDPE), a linear low density polyethylene (LLDPE), a medium density polyethylene (MDPE), or a high density polyethylene (HDPE) constituted of a copolymer of ethylene with one or more polar monomers of acrylic acid, methacrylic acid, glycidyl methacrylate, maleic acid, or maleic anhydride or any combination thereof.

11. The water barrier according to claim 1, wherein the polyethylene-based semi-conducting polymer has an elastic modulus of at least 0.5 GPa.

12. The water barrier according to claim 1, wherein the polyethylene-based semi-conducting polymer comprises 4 to 40 weight % particulate carbon, silver or aluminium.

13. The water barrier according to claim 1, wherein the thickness t₂ of the outer layer is from 1.5 to 5 mm.

14. A power cable comprising the water barrier according to claim 1, the water barrier surrounding a cable core of said power cable.

15. A method of manufacturing a water barrier for surrounding a cable core, the method comprising the steps of:
a) providing a layer of lead-free metal foil,
b) welding said layer around the cable core,
c) depositing onto the outer surface of the metal foil layer by extrusion a layer of adhesive material, and
d) depositing onto the outer surface of the intermediate layer of adhesive material by extrusion a layer of a polyethylene-based polymer having an elastic modulus higher than 0.5 GPa
